(19) United States
(12) Patent Application Publication
(10) Pub. No.: US 2022/0341396 A1
(43) Pub. Date: Oct. 27, 2022

(54) METHOD FOR LIFTING/LOWERING LONG OBJECT IN WIND POWER GENERATING APPARATUS

(71) Applicant: MITSUBISHI HEAVY INDUSTRIES, LTD., Tokyo (JP)

(72) Inventors: Tatsuya SAKAUE, Tokyo (JP); Tomokazu YAMADA, Tokyo (JP); Yosuke MIDORIKAWA, Tokyo (JP)

(21) Appl. No.: 17/485,916

(22) Filed: Sep. 27, 2021

(30) Foreign Application Priority Data
Apr. 21, 2021 (JP) 2021-071524

(51) Int. Cl. F03D 13/10; B66C 23/20

(52) U.S. Cl. CPC F03D 13/10; B66C 23/207; F05B 2240/916

(57) ABSTRACT

A method for lifting/lowering a long object in a wind power generating apparatus which includes a rotatably disposed rotor head, the rotor head having an openable and closable opening which causes an interior space of the rotor head and an exterior of the rotor head to communicate with each other, the interior space being disposed with a long jig for hanging the long object, the method includes a horizontal movement step of moving the long object in a horizontal attitude along a horizontal direction to be close to the opening or to be away from the opening in the interior space, an attitude change step of changing an attitude of the long object between the horizontal attitude and a vertical attitude vertically above the opening in the interior space, and a lifting/lowering step of lifting/lowering the long object in the vertical attitude while hanging the long object from the jig.

### TECHNICAL FIELD

The present disclosure relates to a method for lifting/lowering a long object in a wind power generating apparatus.

### BACKGROUND

Patent Document 1 describes a method for lifting/lowering a device in a rotor head, in a wind power generating apparatus.

### CITATION LIST

### Patent Literature

Patent Document 1: JP4551491B

### SUMMARY

However, the method of Patent Document 1 does not assume a long object such as a hydraulic cylinder as the device in the rotor head. Since a space in the rotor head is narrow, an operational restriction different from a case where a device which is not the long object is lifted/lowered is imposed when the long object is taken out of the rotor head to be down on the ground or is lifted toward the rotor head from the ground to be housed in the rotor head.

In view of the above, an object of at least one embodiment of the present disclosure is to provide a method capable of lifting/lowering the long object in the wind power generating apparatus.

In order to achieve the above object, a method according to the present disclosure is a method for lifting/lowering a long object in a wind power generating apparatus which includes a rotatably disposed rotor head, the rotor head having an openable and closable opening which causes an interior space of the rotor head and an exterior of the rotor head to communicate with each other, the interior space being disposed with a long jig for hanging the long object, the method including a horizontal movement step of moving the long object in a horizontal attitude along a horizontal direction to be close to the opening or to be away from the opening in the interior space, an attitude change step of changing an attitude of the long object between the horizontal attitude and a vertical attitude vertically above the opening in the interior space, and a lifting/lowering step of lifting/lowering the long object in the vertical attitude while hanging the long object from the jig.

According to a method of the present disclosure, it is possible to lift/lower a long object in a wind power generating apparatus by moving the long object in a horizontal attitude along a horizontal direction in an interior space of a rotor head, changing an attitude of the long object between the horizontal attitude and a vertical attitude above an opening formed in the rotor head in the interior space of the rotor head, and lifting/lowering the long object in the vertical attitude while hanging the long object from a jig.

### BRIEF DESCRIPTION OF DRAWINGS

FIG. 1 is a configuration view of a wind power generating apparatus to which a method according to an embodiment of the present disclosure is applied.

FIG. 2 is a schematic cross-sectional view of a rotor head and a nacelle of the wind power generating apparatus to which the method according to an embodiment of the present disclosure is applied.

FIG. 3 is a flowchart of a case in which a long object is lowered in the method according to an embodiment of the present disclosure.

FIG. 4 is a flowchart of a case in which the long object is lifted in the method according to an embodiment of the present disclosure.

FIG. 5 is a view for describing a jig mounting step in the method according to an embodiment of the present disclosure.

FIG. 6 is a schematic view showing an example of fixing the jig in a horizontal state.

FIG. 7 is a view for describing an operation in a horizontal movement step in the method according to an embodiment of the present disclosure.

FIG. 8 is a view for describing the operation in a horizontal movement step in the method according to an embodiment of the present disclosure.

FIG. 9 is a view for describing an operation in an attitude change step in the method according to an embodiment of the present disclosure.

FIG. 10 is a view for describing the operation in an attitude change step in the method according to an embodiment of the present disclosure.

FIG. 11 is a view for describing an operation in a lowering step in the method according to an embodiment of the present disclosure.

### DETAILED DESCRIPTION

A method according to an embodiment of the present disclosure, that is, a method for lifting/lowering a long object in a wind power generating apparatus will be described below with reference to the drawings. The embodiment to be described below indicates one aspect of the present disclosure, does not intend to limit the disclosure, and can optionally be modified within a range of a technical idea of the present disclosure.

<Configuration of Wind Power Generating Apparatus to which Method According to Embodiment of Present Disclosure is Applied>

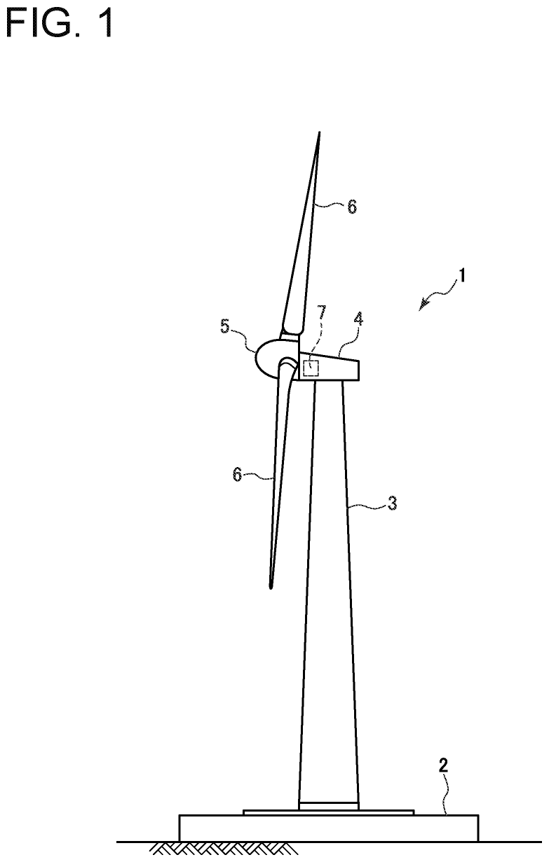

As shown in FIG. 1, a wind power generating apparatus 1 includes a tower 3 disposed on a foundation 2, a nacelle 4 disposed at an upper end of the tower 3, and a rotor head 5 rotatably supported on a front-end side of the nacelle 4. The rotor head 5 is mounted with a plurality of wind turbine blades 6 radially disposed around a rotational axis thereof. The number of wind turbine blades 6 mounted on the rotor head 5 is optional.

The wind power generating apparatus 1 includes a fixing device 7 for fixing the rotor head 5 to prevent a rotation thereof. The configuration of the fixing device 7 is not particularly limited. The fixing device 7 may be a braking device for a main shaft of the rotor head 5, a block pin capable of stopping a rotation of the rotor head 5, a device for adjusting a pitch of the wind turbine blade 6, or the like. The device for adjusting the pitch of the wind turbine blade 6 prevents the rotor head 5 from rotating by wind by setting the pitch of the wind turbine blade 6 to a feather position, and thus can function as the fixing device 7. Moreover, as the fixing device 7, not a single configuration, but a configuration of a combination of at least two devices given above may be adopted.

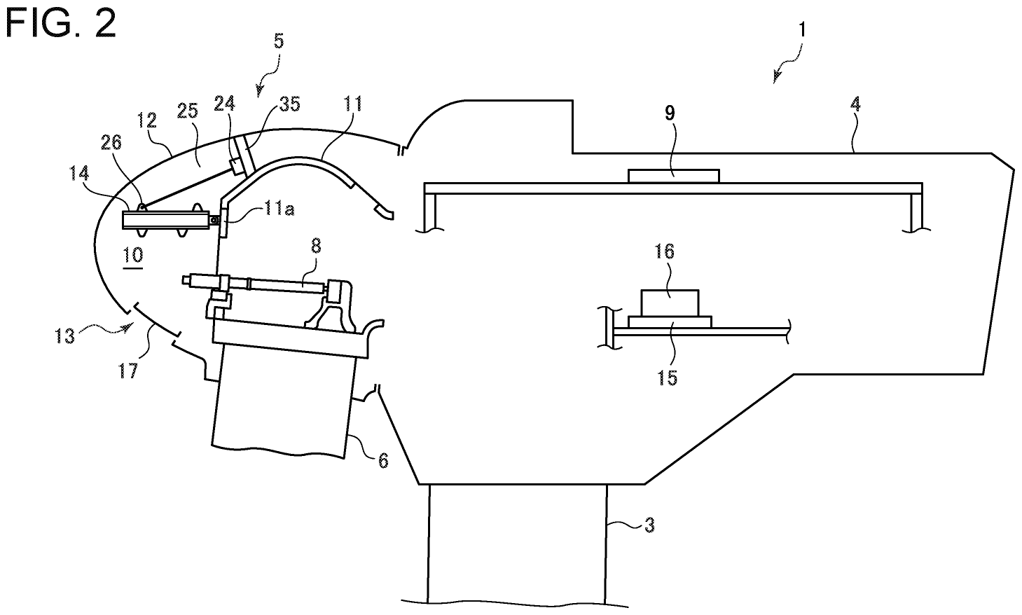

As shown in FIG. 2, the rotor head 5 includes a rotor head body 11 mounted with the wind turbine blade 6 as well as coupled to a main shaft (not shown), and a capsule 12 disposed around the rotor head body 11 as well as configured to be integrally rotatable with the rotor head 5. Inside the capsule 12, an interior space 10 of the rotor head 5 (also including an interior space of the rotor head body 11) is formed. In the interior space 10, a hydraulic cylinder 8 is disposed which serves as a device for adjusting the pitch of each wind turbine blade 6. When the hydraulic cylinder 8 is disposed in the interior space 10, the hydraulic cylinder 8 is disposed in an attitude where a longitudinal direction thereof extends along the horizontal direction, that is, in the horizontal attitude. However, “horizontal” of the “horizontal direction” and the “horizontal attitude” in the present disclosure is not limited to a complete horizontal, but also includes a state slightly inclined with respect to complete horizontal.

The capsule 12 includes openings 13 which cause the interior space 10 and an exterior of the rotor head 5 to communicate with each other, at least by the number corresponding to the number of wind turbine blades 6, that is, hydraulic cylinders 8. However, FIG. 2 illustrates only one opening 13. Each opening 13 can be opened/closed by a lid 17. When one of the hydraulic cylinders 8 is arranged at a lowest position by rotating the rotor head 5, the respective openings 13 are configured such that one of the openings 13 faces vertically downward.

When the hydraulic cylinder 8 is lifted/lowered by a method to be described later, in the interior space 10, a long jig 14 is provided on a support 11a of the rotor head body 11 disposed in advance. The jig 14 is disposed to be located vertically above the opening 13 facing vertically downward, as well as to extend along the horizontal direction (that is, in the horizontal attitude). A method for providing the jig 14 on the support 11a and the configuration in which the jig 14 is fixed in the horizontal attitude will be described later.

In the nacelle 4, a crane 9 is disposed. The crane 9 is disposed to be movable in a back and forth direction, more specifically, a direction close to or away from the rotor head 5, that is, a right-left direction in FIG. 2. Vertically below the crane 9 in the nacelle 4, a lifting/lowering device 16 such as a winch and a frame 15 thereof used in the method to be described later are detachably disposed.

### Method According to Embodiment of Present Disclosure

Next, a method according to an embodiment of the present disclosure, that is, a method for lifting/lowering a long object in the wind power generating apparatus 1 will be described. The long object lifted/lowered in the method is not particularly limited, but the hydraulic cylinder 8 will be described below as an example of the long object.

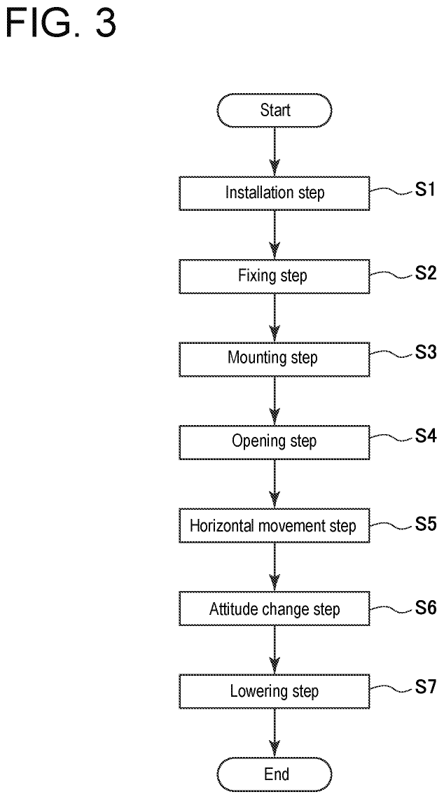

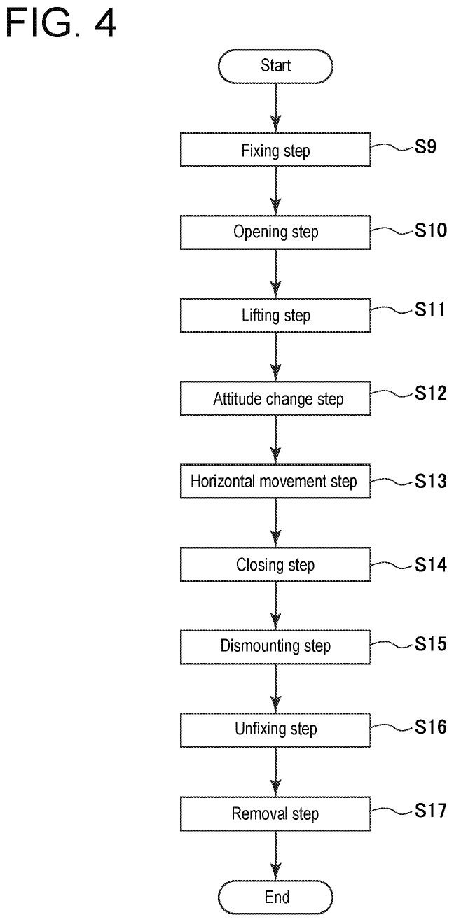

First, the overview of the method will be described. The method includes a method (lowering method) for taking out the hydraulic cylinder 8 disposed in the interior space 10 to the exterior of the rotor head 5 via the opening 13 to be down on the ground, and a method (lifting method) for lifting the hydraulic cylinder 8 on the ground to be inserted into the interior space 10 via the opening 13 and to be installed in the interior space 10. A flowchart of the former is shown in FIG. 3, and a flowchart of the latter is shown in FIG. 4.

As shown in FIG. 3, the lowering method includes an installation step S1 of installing the lifting/lowering device 16 on the frame 15 mounted in the nacelle 4, a fixing step S2 of fixing the rotor head 5 to prevent the rotation thereof, a mounting step S3 of mounting the jig 14 on the support 11a of the rotor head body 11, and an opening step S4 of opening one of the openings 13 such that the opening 13 faces vertically downward. The order of these steps can be changed as needed, except for the need to perform the mounting step S3 and the opening step S4 after the fixing step S2.

The lowering method further includes a horizontal movement step S5 of moving the hydraulic cylinder 8 in the horizontal attitude along the horizontal direction to be close to the opening 13 in the interior space 10 after performing the installation step S1 to the opening step S4, an attitude change step S6 of changing the attitude of the hydraulic cylinder 8 from the horizontal attitude to a vertical attitude above the opening 13 in the interior space 10 after the horizontal movement step S5, and a lowering step S7 (defined as a “lifting/lowering step” together with a lifting step S11 to be described later) of lowering the hydraulic cylinder 8 in the vertical attitude while hanging the hydraulic cylinder 8 from the jig 14 after the attitude change step S6. The above-described opening step S4 may be performed after the horizontal movement step S5 or after the attitude change step S6.

The lifting method basically performs the above-described lowering method in reverse order and includes, as shown in FIG. 4, the lifting step S11 of lifting the hydraulic cylinder 8 on the ground to be inserted into the interior space 10 via the opening 13, an attitude change step S12 of changing the attitude of the hydraulic cylinder 8 from the vertical attitude to the horizontal attitude after the lifting step S11, and a horizontal movement step S13 of moving the hydraulic cylinder 8 in the horizontal attitude along the horizontal direction to be away from the opening 13 in the interior space 10 and installing the hydraulic cylinder 8 at an appropriate position of the interior space 10 after the attitude change step S12. If the rotor head 5 is not fixed to prevent the rotation thereof, it is necessary to perform a fixing step S9 of fixing the rotor head 5 by the fixing device 7 at where a section, in which the hydraulic cylinder 8 is disposed in the interior space 10, is located at the lowest position, before the lifting step S11. Moreover, if the opening 13 is not opened to face vertically downward, it is necessary to perform an opening step S10 of opening the opening 13, before the lifting step S11.

The lifting method further includes a closing step S14 of closing the opening 13 after performing the lifting step S11 to the horizontal movement step S13, a dismounting step S15 of dismounting the jig 14 from the support 11a of the rotor head body 11, an unfixing step S16 of unfixing the rotor head 5, and a removal step S17 of removing the lifting/lowering device 16 and the frame 15 in the nacelle 4. The closing step S14 may be performed after the lifting step S11 or after the attitude change step S12.

Next, the details of the lowering method will be described. As shown in FIG. 2, the installation step S1 includes lifting the lifting/lowering device 16 from the ground into the nacelle 4 by the crane 9 to install the lifting/lowering device 16 on the frame 15 mounted in the nacelle 4. The fixing step S2 includes stopping the rotor head 5 at where the hydraulic cylinder 8 to be lowered is located at the lowest position and fixing the rotor head 5 at the position by the fixing device 7 (see FIG. 1).

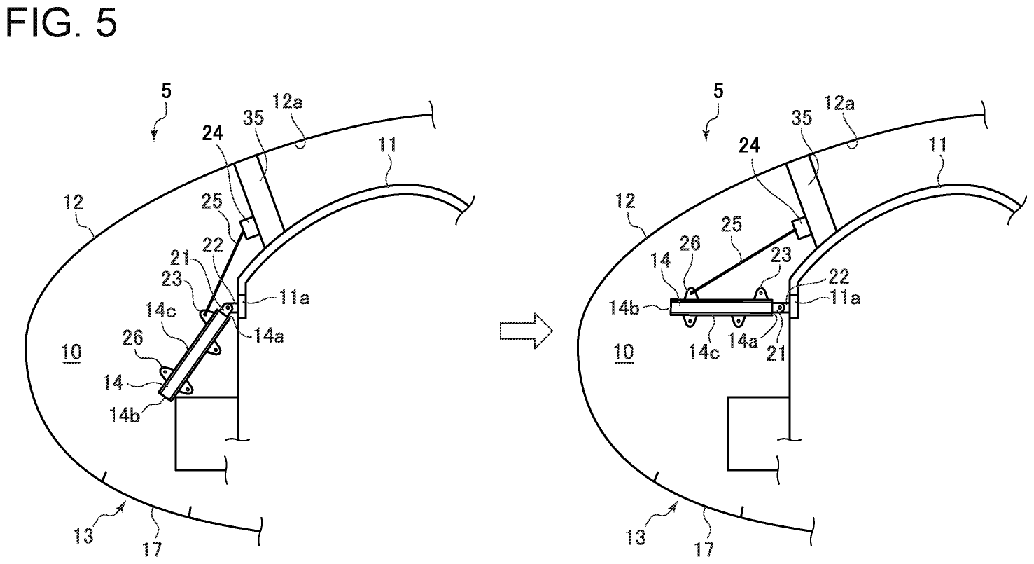

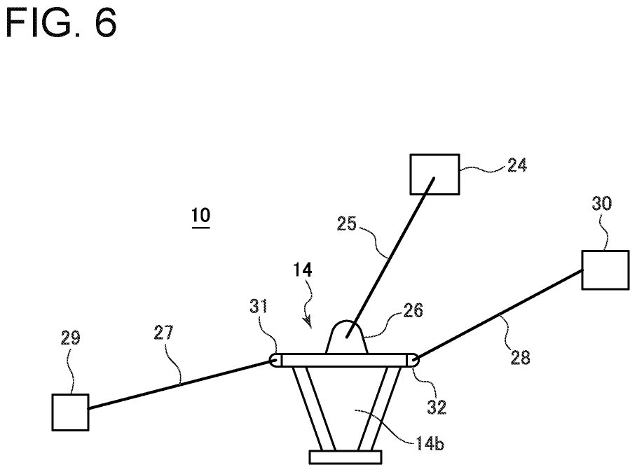

As shown in FIG. 5, the mounting step S3 includes rotatably mounting longitudinal one end 14a of the jig 14 to the support 11a by coupling a flange 21 disposed at the one end 14a and a flange 22 disposed on the support 11a with a pin or the like. A shackle 23 disposed on the side of the one end 14a on an upper surface 14c of the jig 14, and a shackle 24 fixed to a support member 35 for coupling the rotor head body 11 and an inner circumferential surface 12a of the capsule 12 are coupled with a wire 25. Pulling the wire 25, another end 14b of the jig 14 is rotated about the one end 14a of the jig 14, that is, the pin, to set the jig 14 in the horizontal state. The horizontal state of the jig 14 is preferably confirmed by using a level. Thus, it is possible to appropriately set the jig 14 in the horizontal state. In order to maintain the horizontal state, the wire 25 is reconnected to couple the shackle 24, and a mounting part 26 disposed between the shackle 23 and the another end 14b on the upper surface 14c of the jig 14. That is, the horizontal state of the jig 14 is maintained by hanging the jig 14 with the wire 25. However, with only hanging by the wire 25, the another end 14b of the jig 14 swings in the horizontal direction. Thus, as shown in FIG. 6, the jig 14 is hung by wires 27, 28 from the right-left direction as well. That is, shackles 29, 30 fixed to the support member for coupling the inner circumferential surface 12a (see FIG. 5) of the capsule 12 (see FIG. 5) and the rotor head body 11 (see FIG. 5), and shackles 31, 32 disposed on the jig 14 are coupled by the wires 27, 28, respectively. Thus fixing the jig 14 in the horizontal state by hanging the jig 14 from above, and left and right, it is possible to easily and reliably fix the jig 14 in the horizontal state.

As the flange 22, it is possible to use, for example, a hanging hook of an existing accumulator flange. As the shackle 24, it is possible to use, for example, a hanging piece of a bracket of the capsule 12. As the shackle 29, 30, it is possible to use, for example, a bracket utilizing an extra length of a bearing bolt of the wind turbine blade 6.

As shown in FIG. 2, the opening step S4 includes opening the opening 13 by removing the lid 17 from the opening 13. The lid 17 is removed manually. Since the above-described fixing step S2 prevents the rotation of the rotor head 5, it is possible not to change a position of the opening 13 opened to face vertically downward.

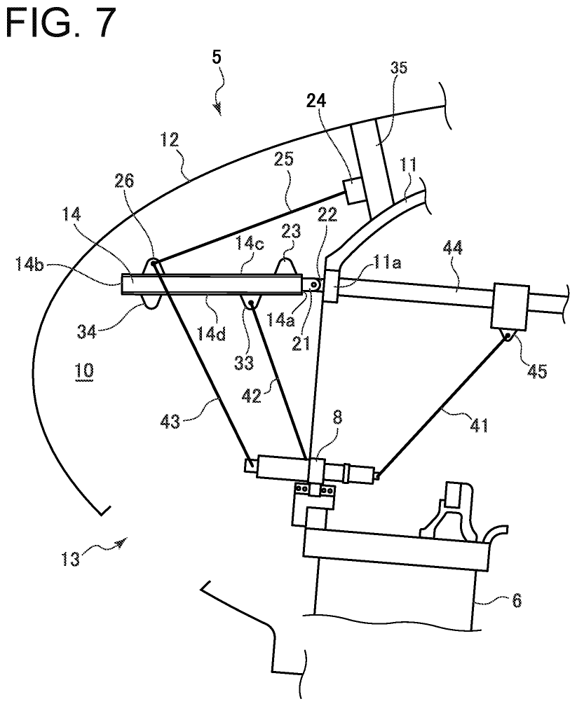

Next, the horizontal movement step S5 will be described. As shown in FIG. 7, after confirming that no pressure is accumulated in a hydraulic accumulator corresponding to the hydraulic cylinder 8 to be lowered, a pipe or the like connected to the hydraulic cylinder 8 is disconnected, and a hydraulic pump corresponding to the hydraulic cylinder 8 is operated as needed to retract a protruding rod of the hydraulic cylinder 8. That is, the hydraulic cylinder 8 is set in a most contracted state. Setting the hydraulic cylinder 8 in the most contracted state, it is possible to easily perform horizontal movement of the hydraulic cylinder 8 in the horizontal movement step S5 even if the interior space 10 is narrow, and to reduce a risk that the hydraulic cylinder 8 hits the inner surface of the capsule 12 or the like when the attitude of the hydraulic cylinder 8 is changed in the attitude change step S6.

In this state, the hydraulic cylinder 8 is coupled to one end of each of three wires 41, 42, 43 at different positions of the hydraulic cylinder 8 in the longitudinal direction. Another end of the wire 41 located on a rearmost side (a position farthest away from the opening 13 in the horizontal direction) among these three wires is coupled to a shackle 45 fixed to an optional column 44 in the interior space 10. Another end of the middle wire 42 among the three wires is coupled to a shackle 33 disposed to be located on the side of the one end 14a of the jig 14 on a lower surface 14d of the jig 14. Another end of the wire 43 located on a frontmost side (a position closest to the opening 13 in the horizontal direction) among the three wires is coupled to the mounting part 26.

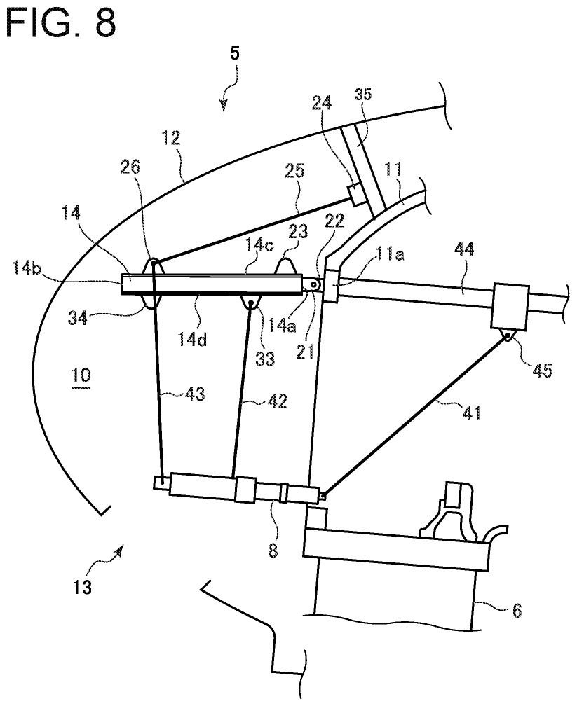

After one end of each of the three wires 41, 42, 43 is coupled to the hydraulic cylinder 8, if the hydraulic cylinder 8 is unfixed in the interior space 10 to gradually weaken hanging with the wire 41, the hydraulic cylinder 8 moves horizontally to be close to the opening 13 in the horizontal attitude along the horizontal direction with being hung from the jig 14 and as shown in FIG. 8, at least a part of the hydraulic cylinder 8 is located vertically above the opening 13. Since the hydraulic cylinder 8 is horizontally moved with being hung from the jig 14, it is possible to easily perform the horizontal movement.

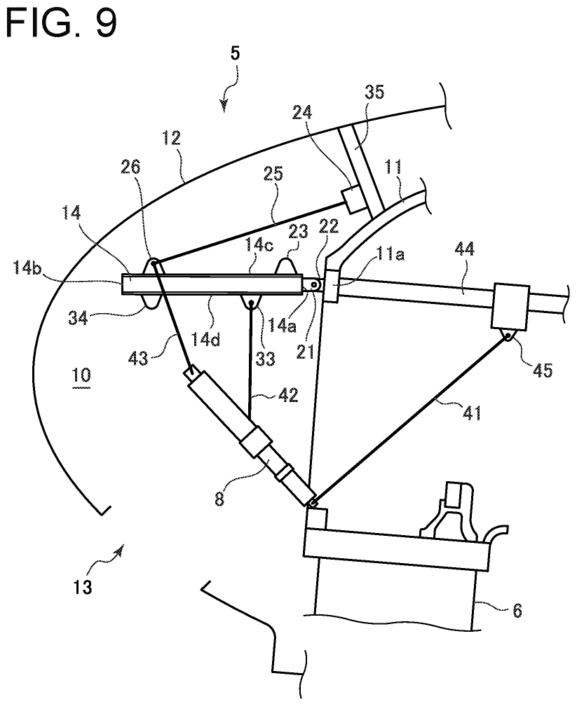

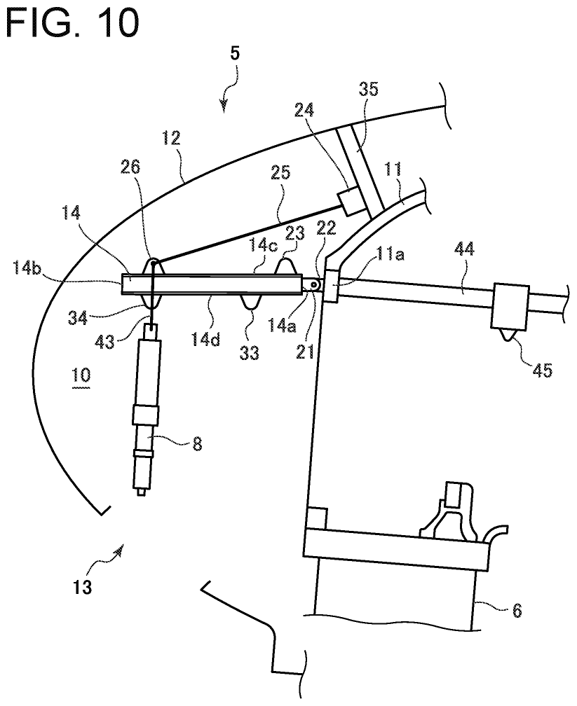

Next, the attitude change step S6 will be described. As shown in FIG. 9, pulling the wire 42, 43, the hydraulic cylinder 8 rotates while lifting vertically above the opening 13 with being hung from the jig 14, and changes its attitude from the horizontal attitude toward the vertical attitude. Removing the wire 41, 42, as shown in FIG. 10, the hydraulic cylinder 8 is hung by the wire 43 in the vertical attitude vertically above the opening 13. Since the hydraulic cylinder 8 changes its attitude with being hung from the jig 14, it is possible to easily change the attitude of the hydraulic cylinder 8.

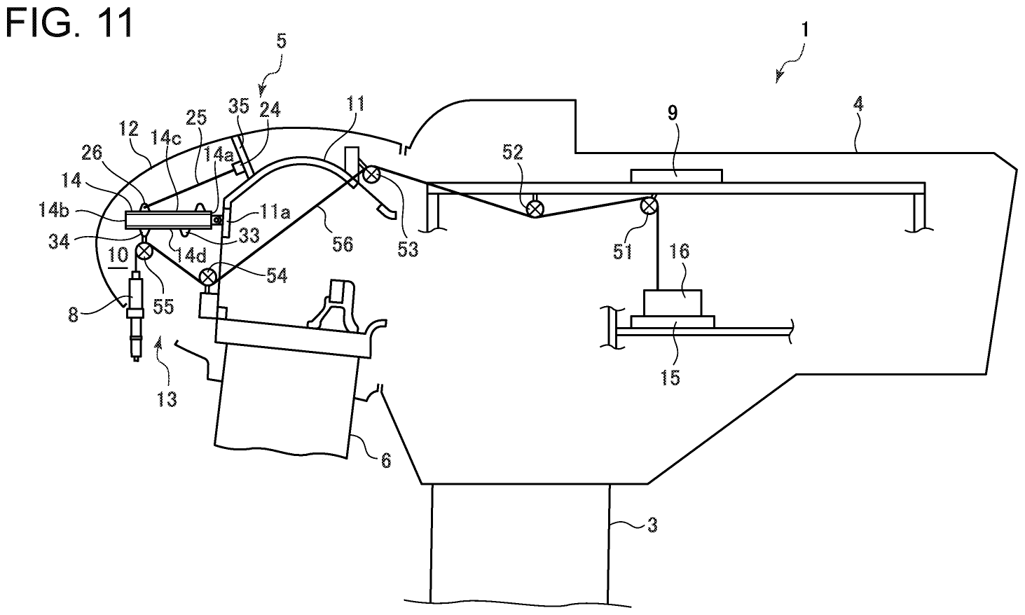

Next, the lowering step S7 will be described. As shown in FIG. 11, a lifting/lowering wire 56 wound or unwound by the lifting/lowering device 16 is coupled to the hydraulic cylinder 8 through, for example, five pulleys 51 to 55 to shift a load of the hydraulic cylinder 8 to the wire 56, and then the wire 43 is separated from the hydraulic cylinder 8. The pulley 55 closest to the hydraulic cylinder 8 is coupled to the shackle 34 disposed to be located on the side of the another end 14b of the jig 14 on the lower surface 14d of the jig 14. The number of pulleys through which the wire 56 passes is not limited to five, but the optional number of pulleys may be used. In addition, positions where the respective pulleys are disposed are also optional.

The hydraulic cylinder 8 is hung from the jig 14 in the vertical attitude by the wire 56 passing through the pulley 55. In this state, the lifting/lowering device 16 unwinds the wire 56, thereby lowering the hydraulic cylinder 8. The lowering hydraulic cylinder 8 gets out of the rotor head 5 via the opening 13 and is further lowered to be down on the ground. At this time, since the position of the opening 13 opened to face vertically downward does not change, it is possible to get the hydraulic cylinder 8 out of the rotor head 5 via the opening 13 just by lowering the hydraulic cylinder 8. Thus, it is possible to set the hydraulic cylinder 8 disposed in the interior space 10 down on the ground.

As described when describing the overview of the method according to an embodiment of present disclosure, performing the procedure of the above-described lowering method in reverse order, it is possible to lift the hydraulic cylinder 8 on the ground to be installed in the interior space 10 of the rotor head 5.

Thus, it is possible to lift/lower the hydraulic cylinder 8 in the wind power generating apparatus 1 by moving the hydraulic cylinder 8 in the horizontal attitude along the horizontal direction in the interior space 10 of the rotor head 5, changing the attitude of the hydraulic cylinder 8 between the horizontal attitude and the vertical attitude above the opening 13 formed in the rotor head 5 in the interior space 10 of the rotor head 5, and lifting/lowering the hydraulic cylinder 8 in the vertical attitude while hanging the hydraulic cylinder 8 from the jig 14.

The contents described in the above embodiments would be understood as follows, for instance.

[1] A method according to one aspect is a method for lifting/lowering a long object (hydraulic cylinder 8) in a wind power generating apparatus (1) which includes a rotatably disposed rotor head (5), the rotor head (5) having an openable and closable opening (13) which causes an interior space (10) of the rotor head (5) and an exterior of the rotor head (5) to communicate with each other, the interior space (10) being disposed with a long jig (14) for hanging the long object (8), the method including a horizontal movement step (S5/S13) of moving the long object (8) in a horizontal attitude along a horizontal direction to be close to the opening (13) or to be away from the opening (13) in the interior space (10), an attitude change step (S6/S12) of changing an attitude of the long object (8) between the horizontal attitude and a vertical attitude vertically above the opening (13) in the interior space (10), and a lifting/lowering step (lowering step S7/lifting step S11) of lifting/lowering the long object (8) in the vertical attitude while hanging the long object (8) from the jig (14).

With the method of the present disclosure, it is possible to lift/lower the long object in the wind power generating apparatus by moving the long object in the horizontal attitude along the horizontal direction in the interior space of the rotor head, changing the attitude of the long object between the horizontal attitude and the vertical attitude above the opening formed in the rotor head in the interior space of the rotor head, and lifting/lowering the long object in the vertical attitude while hanging the long object from the jig.

[2] A method according to another aspect is the method of [1], wherein the horizontal movement step (S5/S13) and the attitude change step (S6/S12) are performed with the long object (8) being hung from the jig (14).

With the above configuration, it is possible to easily perform the horizontal movement and the attitude change of the long object.

[3] A method according to still another aspect is the method of [1] or [2], further including an opening step (S4/S10) of opening the opening (13) to face vertically downward.

The long object (8) is withdrawn from the interior space (10) to the exterior of the rotor head (5) or is inserted from the exterior of the rotor head (5) into the interior space (10) via the opening (13), when the long object (8) is lifted/lowered in the lifting/lowering step (S7/S11).

With the above configuration, lifting/lowering the long object by opening the opening to face vertically downward, it is possible to withdraw the long object to the exterior of the rotor head and to insert the long object into the interior space.

[4] A method according to yet another aspect is the method of any one of [1] to [3], wherein the wind power generating apparatus (1) includes a nacelle (4) for rotatably supporting the rotor head (5), wherein the method further includes an installation step (S1) of installing a lifting/lowering device (16) in the nacelle (4), and wherein a wire (56) coupled at one end to the long object (8) is coupled at another end to the lifting/lowering device (16) via at least one pulley (51 to 55), and the lifting/lowering step (S7/S11) is performed by winding or unwinding the wire (56) with the lifting/lowering device (16).

With the above configuration, it is possible to lift/lower the long object by the lifting/lowering device.

[5] A method according to yet another aspect is the method of any one of [1] to [4], further including a mounting step (S3) of mounting the jig (14) in the interior space (10).

The mounting step (S3) includes rotatably mounting one end (14a) of the long jig (14) on a support (11a) disposed in the interior space (10), and fixing the jig (14) in a horizontal state by rotating another end (14b) of the jig (14) about the one end (14a).

With the above configuration, it is possible to confirm that the jig is horizontal by using a level when mounting the jig, and thus it is possible to appropriately set the jig in the horizontal state.

[6] A method according to yet another aspect is the method of [5], wherein the jig (14) is fixed in the horizontal state by being hung from above, and left and right.

With the above configuration, it is possible to easily and reliably fix the jig in the horizontal state.

[7] A method according to yet another aspect is the method of any one of [1] to [6], wherein the long object is a hydraulic cylinder (8) disposed in the interior space (10).

With the above configuration, it is possible to lift/lower the long hydraulic cylinder in the wind power generating apparatus.

[8] A method according to yet another aspect is the method of [7], wherein the wind power generating apparatus (1) includes a fixing device (7) for fixing the rotor head (5) to prevent a rotation thereof, and wherein the method includes a fixing step (S2) of fixing the rotor head (5) by the fixing device (7) at where the hydraulic cylinder (8) disposed in the interior space (10) is located at a lowest position, before the hydraulic cylinder (8) is moved along the horizontal direction to be close to the opening (13), or a fixing step (S9) of fixing the rotor head (5) by the fixing device (7) at where a section, in which the hydraulic cylinder (8) is disposed in the interior space (10), is located at the lowest position, before the hydraulic cylinder (8) is lifted by the lifting/lowering step (S11).

With the above configuration, since the position of the opening is not changed without the rotor head rotating during lifting/lowering of the long object, lifting/lowering the long object, it is possible to withdraw the long object to the exterior of the rotor head and to insert the long object into the interior space.

[9] A method according to yet another aspect is the method of [7] or [8], wherein the horizontal movement step (S5/S13) includes moving the hydraulic cylinder (8) in a most contracted state along the horizontal direction.

With the above configuration, it is possible to easily perform horizontal movement of the hydraulic cylinder even if the interior space is narrow.

1. A method for lifting/lowering a long object in a wind power generating apparatus which includes a rotatably disposed rotor head,
the rotor head having an openable and closable opening which causes an interior space of the rotor head and an exterior of the rotor head to communicate with each other, the interior space being disposed with a long jig for hanging the long object,
the method comprising:
a horizontal movement step of moving the long object in a horizontal attitude along a horizontal direction to be close to the opening or to be away from the opening in the interior space;
an attitude change step of changing an attitude of the long object between the horizontal attitude and a vertical attitude vertically above the opening in the interior space; and
a lifting/lowering step of lifting/lowering the long object in the vertical attitude while hanging the long object from the jig.

2. The method according to claim 1,
wherein the horizontal movement step and the attitude change step are performed with the long object being hung from the jig.

3. The method according to claim 1, further comprising an opening step of opening the opening to face vertically downward,
wherein the long object is withdrawn from the interior space to the exterior of the rotor head or is inserted from the exterior of the rotor head into the interior space via the opening, when the long object is lifted/lowered in the lifting/lowering step.

4. The method according to claim 1,
wherein the wind power generating apparatus includes a nacelle for rotatably supporting the rotor head,
wherein the method further comprises an installation step of installing a lifting/lowering device in the nacelle, and
wherein a wire coupled at one end to the long object is coupled at another end to the lifting/lowering device via at least one pulley, and the lifting/lowering step is performed by winding or unwinding the wire with the lifting/lowering device.

5. The method according to claim 1, further comprising a mounting step of mounting the jig in the interior space,
the mounting step includes:
rotatably mounting one end of the long jig on a support disposed in the interior space; and
fixing the jig in a horizontal state by rotating another end of the jig about the one end.

6. The method according to claim 5,
wherein the jig is fixed in the horizontal state by being hung from above, and left and right.

7. The method according to claim 1,
wherein the long object is a hydraulic cylinder disposed in the interior space.

8. The method according to claim 7,
wherein the wind power generating apparatus includes a fixing device for fixing the rotor head to prevent a rotation thereof, and
wherein the method comprises:
a fixing step of fixing the rotor head by the fixing device at where the hydraulic cylinder disposed in the interior space is located at a lowest position, before the hydraulic cylinder is moved along the horizontal direction to be close to the opening; or
a fixing step of fixing the rotor head by the fixing device at where a section, in which the hydraulic cylinder is disposed in the interior space, is located at the lowest position, before the hydraulic cylinder is lifted by the lifting/lowering step.

9. The method according to claim 7,
wherein the horizontal movement step includes moving the hydraulic cylinder in a most contracted state along the horizontal direction.
